(19) United States
(12) Patent Application Publication
(10) Pub. No.: US 2011/0319021 A1
(43) Pub. Date: Dec. 29, 2011

(54) INTRA-ORAL TISSUE CONDUCTION MICROPHONE

(75) Inventors: Timothy L. PROULX, Santa Cruz, CA (US); Reza KASSAYAN, Atherton, CA (US)

(73) Assignee: Sonitus Medical, Inc., San Mateo, CA (US)

(21) Appl. No.: 13/118,285

(22) Filed: May 27, 2011

Related U.S. Application Data
(60) Provisional application No. 61/349,508, filed on May 28, 2010.

(51) Int. Cl. H04W 88/00; H04R 1/00

(52) U.S. Cl. 455/41.2; 381/151

(57) ABSTRACT

Intra-oral tissue conduction microphone apparatus and methods are described for internal, but non-surgically installed microphones located in the oral cavity. An intra-oral tissue conduction microphone may be attached, adhered or integrated with a removable dental appliance which is positioned against the inside surfaces of the cheek, palate or gingiva. The sensor serves as a component in a non-observable hearing, body sound monitoring or communications device that can operate in environments incompatible with most existing devices. Generally, a piezoelectric film serves as the sensor that is well matched to tissue and which directly converts to an electrical signal by the piezoelectric effect signals which are received through the oral mucosa, gingiva or palate.

### CROSS-REFERENCE TO RELATED APPLICATIONS

This application claims the benefit of priority to U.S. Prov. App. 61/349,508 filed May 28, 2010, which is incorporated herein by reference in its entirety.

### FIELD OF THE INVENTION

The present invention relates to methods and apparatuses for intra-oral sensors for detection of tissue-conducted vibrations generated by audible or biophysical sounds which may be employed in hearing devices, systems for physical or health monitoring or communications devices.

### BACKGROUND OF THE INVENTION

Tissue contact vibration sensors (contact microphones) have been widely employed in electronic stethoscopes for sensing sounds originating from the body, such as the heart beat, blood flow or respiration. These sensors (or transducers) are placed in contact with the skin or soft tissue and generate an electrical signal in response to vibrations propagating through the tissue induced by biophysical processes. Another type of electronic stethoscope in wide use is the throat microphone which is used to detect tissue vibrations induced by user vocalization. Acoustic (vibration) waves generated by the vocal chords propagate through hard and soft tissue surrounding the larynx and are detected as speech by the externally mounted contact microphone (U.S. Pat. Nos. 4,607,383, 3,746,789). All patents or patent applications referred to throughout are incorporated by reference herein.

Other tissue contact microphones employed for detection of user speech are typically externally mounted on the skin of the forehead, behind the ear on the mastoid bone or within the ear canal. In contrast with the sensors mounted at the throat, these microphones detect vibrations induced by resonances of the larynx and other portions of the vocal tract (hard/soft palate, tongue, lips, teeth) that propagate through the bone of the skull (via bone conduction) and then through the surrounding skin tissue. Non-audible murmur (NAM) microphones are designed to conduct minute sound vibrations conducted primarily in the soft tissue surrounding the oral cavity and are mounted above soft tissue near the jaw behind the ear.

Examples of externally applied tissue contact sensor designs for detecting body sounds and/or speech include a capacitive plate microphone structure integrated into a sealed diaphragm (U.S. Pat. No. 6,498,854), a thin film piezoelectric polymer positioned over a hollow cavity (U.S. Pat. Nos. 6,261,237, 6,937,736), an electret microphone integrated into a housing with a second diaphragm in contact with a tissue coupler (U.S. Pat. No. 7,433,484) and an open condenser microphone coupled to a soft silicone pad.

Tissue contact microphones utilize diverse architectures, but they invariably incorporate a contact surface that is matched to the acoustic impedance of the skin or tissue, such as rubber, polyurethane or plastic. The tissue-matched contact material efficiently couples sound pressure waves traveling through the tissue to the transducer while making the device less sensitive to sound propagating through air. As a result, the sensors are effective at reducing environmental noise and may be suited for use as two-way communication devices in noisy environments, such as industrial locations, moving vehicles or on the battlefield.

A recent study evaluated the performance of several throat and skull-mounted tissue contact microphones in comparison to a boom (air-conducted) microphone and demonstrated the improved speech-to-noise ratio of the contact microphones. The study also found speech intelligibility inferior to the boom microphone, due in theory to reduced information encoded from soft articulators such as the tongue and lips. However, in environments where excessive ambient noise or equipment restrictions, such as full head helmets, protective suits and underwater equipment, preclude use of an air-conducted microphone, reduced speech intelligibility clearly may be tolerated, as numerous contact microphone systems are commercially marketed.

Existing systems relying on tissue contact microphones for throat, ear or bone-conducted speech provide significant advantages, but require externally mounted sensors, electronics and/or batteries. This equipment can be bulky and easily observable, interfere with other equipment such as helmets and protective gear, may occlude the ear canal and may not be used in wet and/or harsh environments.

A related development in the field of tissue contact sensors involves the fully implantable hearing aid, where the microphone portion is installed subcutaneously just above and behind the ear or within the bony wall of the auditory canal. In contrast with the aforementioned sensors designed to detect user's speech, the implanted hearing aid microphone is designed to respond to ambient environmental sounds (U.S. Pat. Nos. 6,516,228, 6,626,822, 7,204,799 and 7,354,394). In these systems, signals detected by the microphone may be processed, amplified and sent to an implanted transducer for stimulation of the middle ear or to electrodes for stimulation of the auditory nerve. The thin layer of skin positioned over the implanted microphone acts as a diaphragm and couples the mechanical vibrations induced by air pressure disturbances to the embedded sensor, typically an electret microphone. An implanted microphone has been measured with a flat sensitivity response of 1.5 mV/Pa up to above 5 kHz and tests of speech intelligibility with the same have demonstrated perfect word recognition with external sound fields of 70 dB SPL.

An implantable microphone as part of a fully implantable hearing system benefits the user in several ways: the hearing system is completely unobservable, eliminating the appearance of a handicap; it does not occlude the ear canal, eliminating comfort/incompatibility issues and improving low frequency sound perception for those with partial hearing loss; and it allows use in environments or activities incompatible with traditional hearing aids. However, a significant drawback is that a surgical procedure is required to install or remove the microphone, battery and signal conditioning/amplification electronics and there must be some means to externally charge the implanted battery. Additionally, the implanted microphone relies on several media conversion stages between vibrations at the skin surface and the electrical signal, limiting overall device performance.

### SUMMARY OF THE INVENTION

This invention seeks to address the aforementioned limitations of tissue-implanted microphones and externally applied tissue contact microphones to realize the indicated benefits of this type of sensor in an internal, but non-surgically installed (i.e. removable) microphone located in the oral cavity. Positioned against the inside surfaces of the cheek, palate or gingiva, the sensor serves as a component in a non-observable hearing, body sound monitoring or communications device that can operate in environments incompatible with most existing devices.

Piezoelectric film such as PVDF (polyvinylidene fluoride) is well suited for use as an intra-oral tissue contact sensor due to its high piezoelectric voltage constant, g, which relates voltage to induced strain, its low mechanical impedance, which is well matched to tissue and its general robustness and mechanical stability. Additionally, with piezoelectric film, tissue vibration is directly converted to an electrical signal by the piezoelectric effect, in contrast to contact sensors that rely on conversion of mechanical vibration to pressure changes in an enclosed air cavity for subsequent detection by an air-conduction microphone (such as those described in U.S. Pat. Nos. 6,516,228 and 7,433,484). As previously mentioned, all patents or patent applications referred to throughout are incorporated by reference herein.

When clamped to a curved open frame structure, PVDF film provides very high sensitivity to normally directed mechanical displacement and its frequency response is flat when operated below resonance. The curvature translates normally directed pressure into tensile stresses along the film axis that can be much larger than the applied stress. The induced film strain generates charge on the film electrodes in proportion to the applied pressure. Film thickness, radius of curvature (ROC) and electrode area may be adjusted to affect electrical impedance, sensitivity, resonance frequency and mechanical impedance, thus allowing fine tuning to the application.

A removable intra-oral tissue conduction microphone may be attached, adhered or integrated with a removable dental appliance. The dental appliance couples to the teeth, for example the upper back molars, to position the microphone such that it is in contact, such as in intimate contact, with certain soft tissue of the oral cavity. The oral mucosa (inside surface of the cheek) may be used since the microphone is positioned as close to an external sound source as possible to minimize signal attenuation. In alternate examples, the gingiva or palate may be used as alternate positions.

### BRIEF DESCRIPTION OF THE DRAWINGS

FIG. 1A shows an example of how a curvature translates normally directed pressure into tensile stresses along the film axis that can be much larger than the applied stress.

FIG. 1B shows a normal force acting on the end of a beam causing a bending moment in the beam and a tensile stress in the film axis.

FIG. 1C shows a piezoelectric film tissue contact microphone incorporating a film wrapped around a rubber contact pad in which a normal force on the pad generates a tension in the film axis due to the radial expansion of the rubber pad.

FIG. 2A shows a microphone sensor portion of a dental appliance contained in a metal or plastic housing positioned on the lingual or buccal side of the tooth.

FIG. 2B shows a contact lens incorporating a low profile protrusion centered on the frame opening to ensure good contact with the soft tissue and to efficiently couple vibrations to the active portion of the PVDF film.

FIG. 2C shows an example of a frame constructed of a biocompatible metal, such as 304 or 316 stainless steel or titanium.

FIG. 2D shows an example of a microphone sensor constructed by bonding (e.g. with cyanoacrylate, epoxy or double-sided adhesive) or mechanically clamping a layer of PVDF film (e.g. 10 mm×20 mm, 52 micron thick) to a curved and open metal frame.

FIG. 3A shows a piezoelectric film with the stretch direction (1-direction) indicated, where the edges of the film (in the 1-direction) are clamped but the sides are not and further shows an alternate arrangement for a piezoelectric film sensor using a flat open frame where the edges of the film (in the 1-direction) are clamped but the sides are not with the film in a neutral position; also shown is a piezoelectric film sensor using a flat open frame where the edges of the film (in the 1-direction) are clamped but the sides are not with the film deflected from the neutral position.

FIG. 3B shows a design incorporating an electret microphone positioned behind an air cavity and diaphragm with the diaphragm being in contact with a rubber pad for contact with the tissue.

FIG. 3C shows a piezoelectric film sensor incorporating a cantilever beam structure with the film bonded to one surface of the beam with a stiff adhesive (e.g. epoxy) and the end of the beam clamped to the microphone frame.

FIG. 3D shows an example of multiple beam structures with different characteristics incorporated into the microphone to extend the effective frequency response.

FIG. 3E shows an example of how the sensors may generate voltage signals that are summed and amplified to produce a wideband frequency response.

FIG. 3F shows a rubber contact pad incorporating a cylindrical section that is clamped against a stiff platform and surrounded by a piezoelectric film.

FIG. 3G shows an example of a piezoelectric ceramic disc sandwiched between a cylindrical portion of the contact pad and a stiff platform within the microphone housing.

FIG. 4 shows a microphone sensor with pre-amp circuit hard-wired to battery power and downstream electrical stages by means of a conduit connecting the buccal and lingual sides of the appliance routed behind the rear molars.

FIG. 5A shows an example of a dental appliance coupled to the teeth, such as the upper back molars, to position the microphone such that it is positioned as close to an external sound source as possible to minimize signal attenuation, e.g. through the oral mucosa.

FIG. 5B shows a dental appliance coupled to the teeth to position the microphone, e.g., against the palate.

FIG. 5C shows a dental appliance coupled to the teeth to position the microphone, e.g., against the gingiva.

FIG. 6A shows opposing sides of the dental appliance incorporating additional digital signal processing electronics, transmitter or receiver circuitry (or both), an antenna and battery (e.g. lithium ion), depending on the application.

FIG. 6B shows an example of how received signals from the microphone may be stored in a flash memory housed in the dental appliance for analysis at a later time.

### DETAILED DESCRIPTION OF THE INVENTION

In contrast to the subcutaneously-implanted microphone, which detects mechanical vibrations of the overlying (tissue) membrane much as an air-conducted microphone does, an intra-oral microphone used for ambient sound detection must respond to sound pressure waves that couple to and propagate through the soft tissue of the head. The air/tissue boundary of the head acts as a significant barrier to sound transmission due to impedance mismatch and scattering of the signal and only a small portion of the external sound pressure energy is transmitted to the embedded sensor. Normal incidence of a pressure wave at an air/water boundary results in a theoretical loss of 33 dB (99.9%) in acoustic intensity. Scattering effects also come into play and FEA models for a sphere of water in air (approximating the head) predict slightly higher acoustic attenuation.

Therefore an intra-oral tissue conduction microphone used for measuring ambient sound must have sufficient SNR (signal to noise ratio) to overcome the losses at the air/tissue interface while detecting minimum desired ambient sound pressure levels (SPL). An intra-oral tissue microphone used effectively as a component in a hearing device should enable excellent speech intelligibility at 70 dB SPL according to standardized metrics and provide useful performance to below 60 dB SPL, which due to propagation losses translates to less than 30 dB SPL measured at the sensor.

When used for detection of user-generated (i.e. native) sounds, such as speech, respiration or other body sounds, the intra-oral tissue microphone senses vibrations propagating within the user's soft tissue and so is not limited by the air/tissue boundary losses. The soft tissue acts as a low-pass filter, attenuating high frequency sound components, but this is true of any externally mounted tissue-contact microphone as well.

In contrast with throat microphones, which sense vibrations at the larynx without the added shaping of the vocal tract, speech information detected at the intra-oral tissue may include contributions from much of the vocal tract, including the pharynx, hard articulators (hard palate, teeth) and soft articulators (tongue, soft palate). Although the effects of the lips and nasal cavity may be excluded from the intra-oral tissue signal, the speech quality may be noticeably better than that of throat microphones. Skull or ear canal-mounted tissue microphones may provide higher signal quality due to higher content of the vocal tract components in the induced bone vibrations, but the benefit over the intra-oral microphone may be minimal. The inventors have shown good speech fidelity of intra-oral microphones in comparison to air-conducted sound.

Piezoelectric film such as PVDF (polyvinylidene fluoride) is well suited for use as an intra-oral tissue contact sensor due to its high piezoelectric voltage constant, g, which relates voltage to induced strain, its low mechanical impedance, which is well matched to tissue and its general robustness and mechanical stability. Additionally, with piezoelectric film, tissue vibration is directly converted to an electrical signal by the piezoelectric effect, in contrast to contact sensors that rely on conversion of mechanical vibration to pressure changes in an enclosed air cavity for subsequent detection by an air-conduction microphone (such as those described in U.S. Pat. Nos. 6,516,228 and 7,433,484).

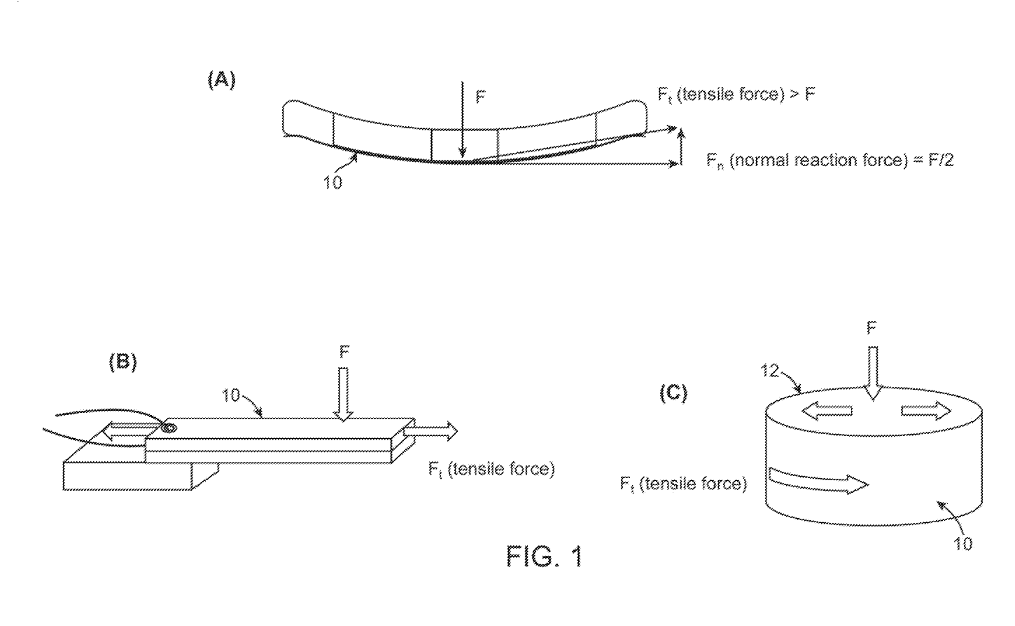

When clamped to a curved open frame structure, PVDF film 10 provides very high sensitivity to normally directed mechanical displacement and its frequency response is flat when operated below resonance. The curvature translates a normally directed pressure or force F into tensile stresses along the film axis that can be much larger than the applied stress (FIG. 1A). The induced film strain generates charge on the film electrodes in proportion to the applied pressure. Film thickness, radius of curvature (ROC) and electrode area may be adjusted to affect electrical impedance, sensitivity, resonance frequency and mechanical impedance, thus allowing fine tuning to the application. FIG. 1B illustrates an example where a normally directed force F may be applied to a film 10 configured into a cantilevered beam structure where the directed force induces a tensile force Ft along a length of the beam. Similarly, FIG. 1C illustrates another example where a normally directed force F may be applied to a curved structure 12 which induces radial expansion over the curved structure and generates a tensile force in the circumferentially bonded film.

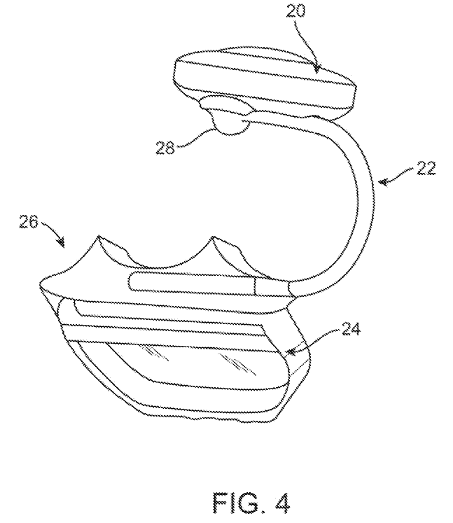

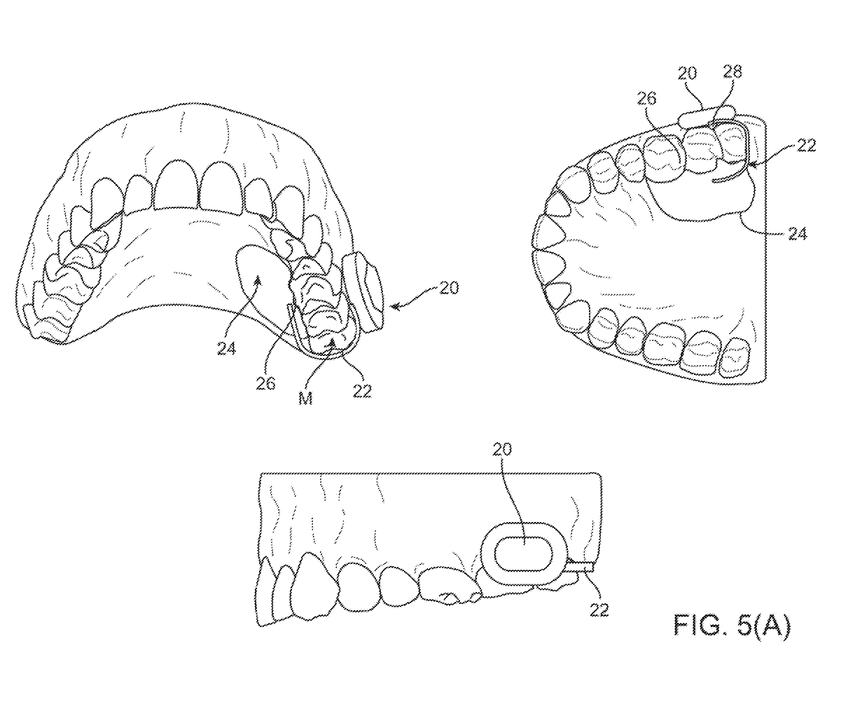

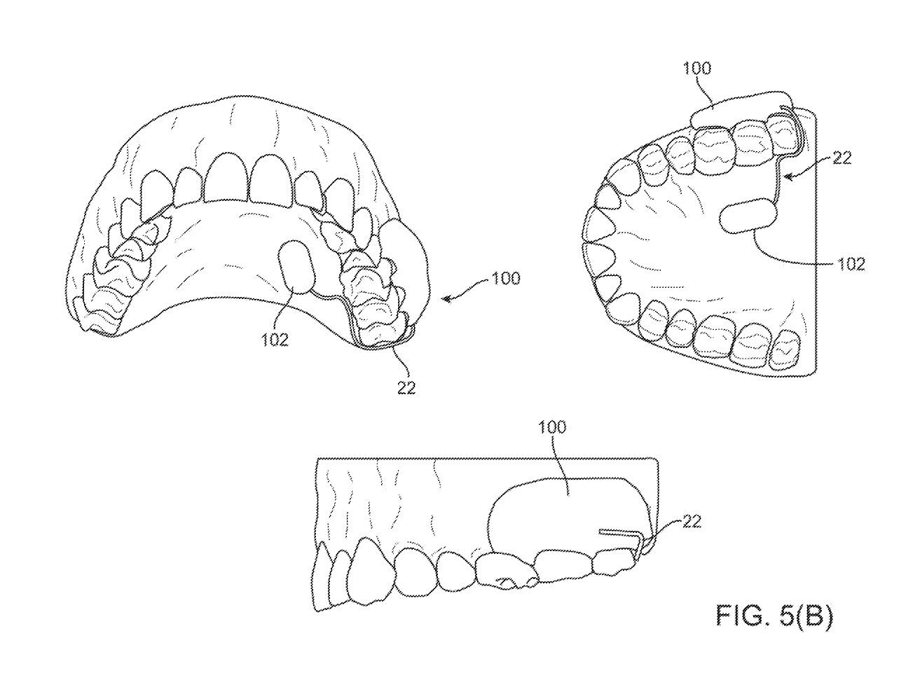

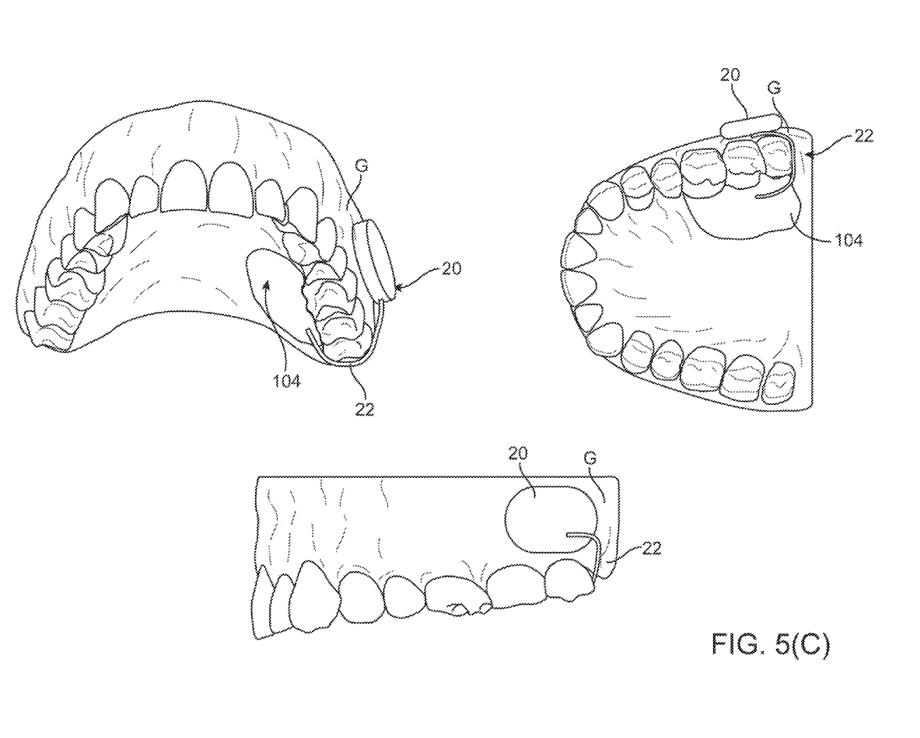

An intra-oral tissue conduction microphone 20 may be attached, adhered or integrated with a removable dental appliance (FIG. 4A). The dental appliance couples to the teeth, for example, the upper back molars M, to position the microphone 20 such that it is in contact with certain soft tissue of the oral cavity. The oral mucosa (inside surface of the cheek) is preferred (FIG. 5A) since the microphone 20 is positioned as close to an external sound source as possible to minimize signal attenuation. The gingiva (FIG. 5C) or palate (FIG. 5B) may also constitute alternate positions. For instance, as shown in FIG. 5B, the buccal portion 100 may retain the battery and/or electronics while a second portion 102 coupled via structural member 22 may contain a microphone (as described herein) positioned by the device against a portion of the soft palate. FIG. 5C shows another variation where the microphone 20 may be positioned against the buccal side of the gingiva G rather than upon the tooth or teeth surface. The second portion 104 may be maintained upon the lingual side as described above while the two portions are coupled to one another around the molar via the structural member 22.

The dental appliance may be a customized device made using a model of the dental structure and fabricated using a thermal forming process (FIG. 4). It may also utilize a non-custom format that can be clamped to the molars by, for example, a connecting wire or other structural member 22 or by stretching a torsional spring, installing in place and then releasing. The connecting wire or other structural member 22 may further function as a conduit to route, e.g., power and/or signals, between the two portions of the device, e.g., the buccal-side microphone 20 which contacts the inner cheek surface and the lingual portion 24 which may hold the battery and/or electronics. Additional mounting techniques described in US patent application 2009/0268932 filed Oct. 29, 2009 as incorporated as reference. The dental appliance incorporates one or more features 26 that may conform to one or more surfaces of the teeth and improve its retention and placement on the teeth.

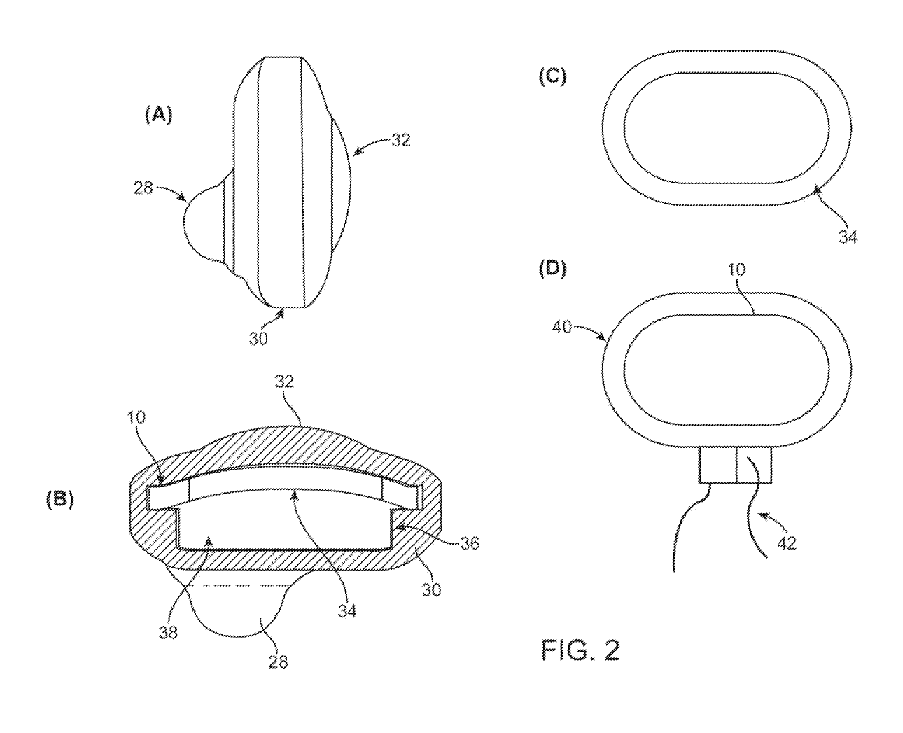

The microphone sensor portion 20 of the dental appliance may be contained, e.g., in a metal, plastic, or other suitable housing 30, positioned on the lingual or buccal side of the tooth, depending on soft tissue contact region (FIG. 2A). The tooth-contact portion of the microphone housing may incorporate a positive feature 28, such as a protrusion that fits in the interstitial space between two molars, to maintain position during use. The tooth contact portion of the microphone 20 housing preferably incorporates a soft plastic or rubber material to reduce vibrations coupled to the housing via bone conduction through the teeth. The housing 30 may for example be over-molded with liquid silicone rubber (LSR) while the portion of the housing 30 which contacts the soft tissue (such as the inner surface of the cheek) may have a silicone or polyurethane contact surface 32. The interior 38 of the housing 30 (which may house, e.g., signal conditioning electronics) incorporates a conductive paint or metal plating 36 to reduce susceptibility of the microphone to electromagnetic interference.

The microphone sensor 20 can be constructed by bonding (e.g. with cyanoacrylate, epoxy or double-sided adhesive 40) or mechanically clamping a layer of PVDF film 10 (e.g. 10 mm×20 mm, 52 micron thick) to a curved and open metal frame 34 (FIG. 2D) such that the stretch direction (known as the “1” direction 44) of the film 10 is along the radius of curvature of the frame 34 (U.S. Pat. No. 6,937,736 incorporated as reference). Other piezoelectric films such as copolymers of PVDF (e.g. PVDF-TrFE) may also be used.

The frame 34 (FIG. 2C) may be constructed of a biocompatible metal, such as 304 or 316 stainless steel or titanium. To minimize the amount of inactive film material (which adds to parasitic capacitance), the width of the frame edge is maintained at a practical minimum to effectively clamp the film and resist deflection. A width of 1-2 mm may be used in one example. Radius of curvature directly impacts microphone sensitivity and resonance frequency (due to the effect on film compliance). A frame radius of, e.g., 5 mm-20 mm, may be used to provide a resonance frequency above the primary speech frequency band (300-4 kHz) while maintaining sufficient device sensitivity. The frame 34 is integrated into the microphone housing 30, e.g., by mechanical fasteners or adhesives. Moreover, the frame 34 may be configured in a number of different shapes, elliptical, circular, etc. depending upon the desired characteristics. Additionally, in alternative variations, the frame may be omitted from the enclosure and/or the piezoelectric film may be secured directly to the housing and unsupported by the frame while the piezoelectric film remains adhered to and in vibrational contact with the contact surface of the enclosure.

A contact layer 32 (lens) of silicone RTV or polyurethane rubber (e.g. NuSil Med-6015 or Dow Corning X3-6121) is cast in place on the PVDF film 10. The contact lens 32 incorporates a low profile protrusion centered on the frame opening to ensure good contact with the soft tissue and to efficiently couple vibrations to the active portion of the PVDF film 10 (FIG. 2B). The lens casting process ensures intimate mechanical contact between the lens and PVDF film over the entire surface and acts to seal the front surface of the microphone assembly from liquid intrusion. An alternate approach is to attach a piezoelectric film to a pre-molded rubber contact layer using a flexible adhesive. This requires care to ensure intimate contact over the active film surface and a water-tight seal at the lens/housing interface. To minimize mechanical loading effects and to reduce the microphone profile, the contact lens may be limited, e.g., to 1-2 mm in thickness.

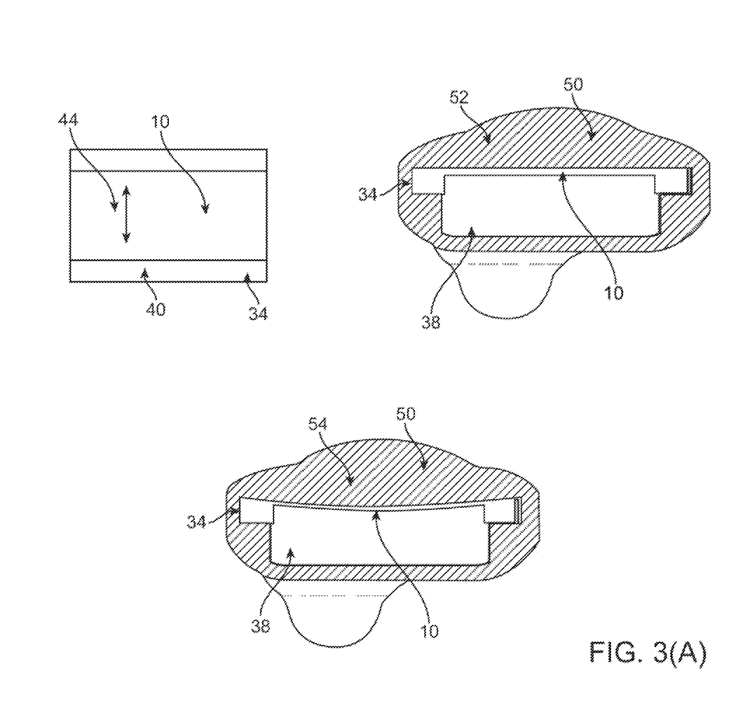

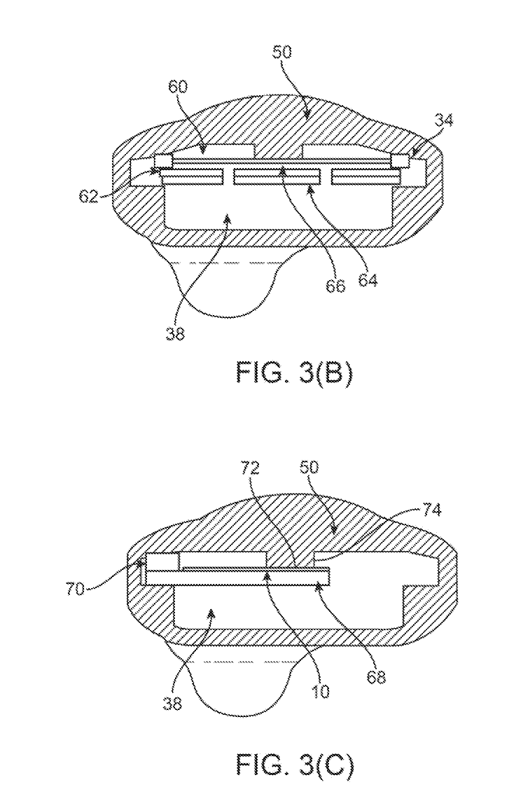

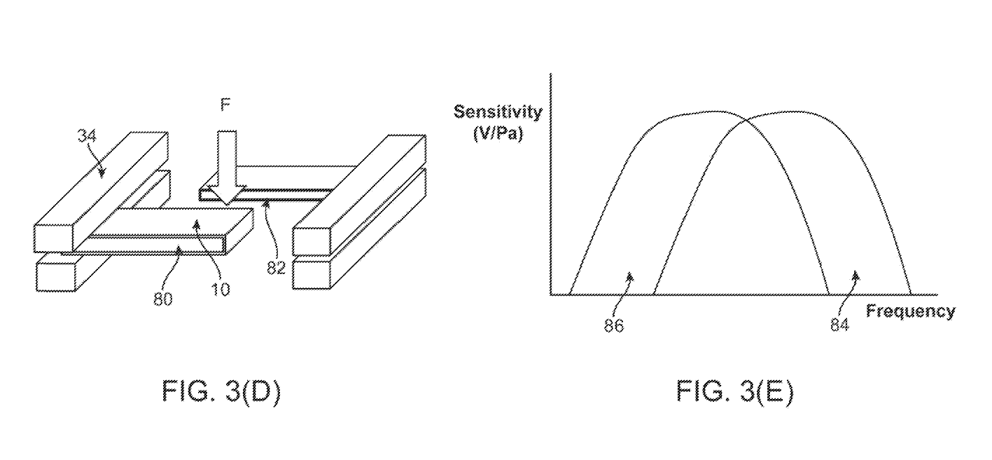

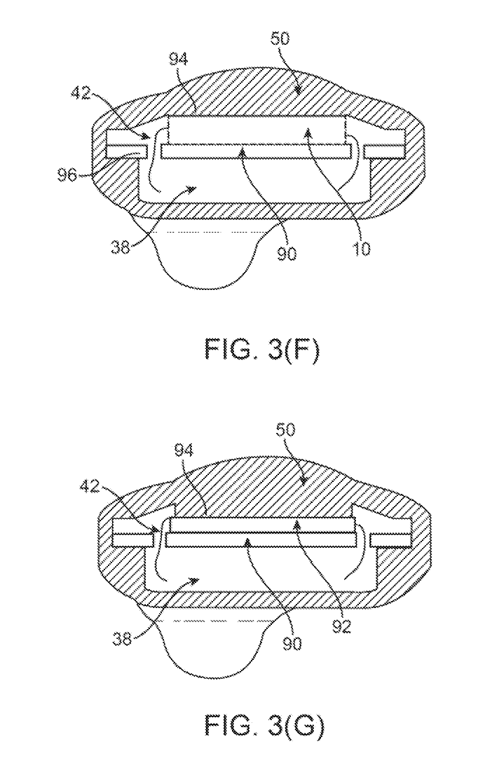

An alternate arrangement for a piezoelectric film sensor 20 uses a flat open frame 34 where the first set of edges of the film opposite to one another (in the I-direction 44) are clamped 40 but the opposing second set of sides are not (FIG. 3A). Static (i.e. “DC”) pressure on the contact lens 50 (such as when installed against the tissue) causes the film to deflect from a straightened or flattened neutral position 52, resulting in the curved configuration 54 described above. Here, the amount of induced curvature 54 is defined by the DC force applied, thus sensitivity and frequency response of the sensor will vary during use. However, this arrangement may result in a lighter/smaller device and simplified construction.

With this architecture, the amount of film curvature may be alternatively adjusted/controlled electronically by applying a DC electric field by means of a DC boost converter circuit connected via leads 42 to first and second electrodes.

Alternately, the desired piezoelectric film curvature may be achieved by adhering the film to a rubber contact layer having a pre-defined curvature 54 using a flexible adhesive and clamping the edges (in the 1-direction) between the frame 34 and housing 30.

A further example of a piezoelectric film sensor 10 incorporates a cantilever beam structure 68. The film 10 is bonded 72 to one surface of the beam with a stiff adhesive (e.g. epoxy) and the end of the beam is clamped 70 to the microphone frame (FIG. 3C). The rubber contact surface 50 incorporates a cylindrical portion 74 that is positioned against the end of the beam such that external sound vibration propagates into the rubber 50 and is transferred to the beam 68. In this arrangement, a normal force acting on the end of the beam 68 causes a bending moment in the beam 68 and a tensile stress in the film axis (FIG. 1B). As with the curved/clamped film 10 arrangement described earlier, the tensile force acts on the edge of the film 10; the small effective area of the film edge causes a much higher stress than that measured at the surface of the film, resulting in higher voltage for the same incoming pressure.

The beam dimensions and material may be adjusted to provide the desired resonance frequency. For example, a steel beam will generate a higher resonance frequency compared to a plastic beam. Multiple beam structures with different characteristics may also be incorporated into the microphone to extend the effective frequency response (FIG. 3D). In this arrangement, a single tissue contact pad is applied to both beams, each having its own frequency response. For instance, a high frequency resonance beam 80 and a low frequency resonance beam 82 each having a film 10 disposed on the beams (as described above) may be secured in proximity to one another along frame 34 and each beam 80, 82 may have the same applied force F. In response to external vibration, the sensors generate voltage signals that are summed and amplified to produce a wideband frequency response (FIG. 3E). That is, the response 84 from the high frequency resonance beam 80 and the response 86 from the low frequency resonance beam 82 may be summed and amplified to produce the wideband frequency response.

Alternatively, a piezoelectric film tissue contact microphone incorporates a film 10 wrapped around a rubber contact pad 12 in which a normal force F on the pad generates a tension in the film 10 axis due to the radial expansion of the rubber pad (FIG. 1C). The rubber contact pad 50 incorporates a cylindrical section 94 that is clamped against a relatively stiff platform 90 (FIG. 3F). The piezoelectric film 10 is wrapped around the cylinder 94 and bonded to itself with an epoxy or cyanoacrylate or other adhesive. A small exposed tab 96 allows access to the bottom electrode. Electrical leads 42 are attached to both top and bottom electrodes and routed through holes in the platform 90 to the microphone enclosure 38 for signal conditioning and amplification.

Another tissue contact microphone incorporates a piezoelectric ceramic disc 92 (e.g. PZT 5H) coupled to a rubber contact pad 50. The disc 92 is sandwiched between (and in contact with) a cylindrical portion 94 of the contact pad and a stiff platform 90 within the microphone housing (FIG. 3G). The disc 92 is bonded to the platform 90 with, e.g. epoxy, or other suitable adhesive materials as known in the art. The diameter and thickness of the disc 92 are controlled to provide a resonance frequency above the audio frequency band of interest. The platform 90 may be fabricated from, e.g., a rigid polymer such as Ultem (polyetherimide) or PEEK (polyether ether ketone), or other suitable polymeric material to provide a mismatched mechanical impedance at the back of the piezo disc and increase sensitivity. Electrical leads 42 are bonded or soldered to top and bottom piezo electrodes and routed to the enclosure 38 for connection to signal conditioning electronics. As with the piezoelectric film, vibrations coupled to the ceramic 92 induce a strain in the material, generating a charge. In this arrangement, the piezoelectric ceramic 92 operates in its thickness mode (3-direction, along the poling direction) and ceramics like PZT5H are considerably more efficient than film in this mode. However, the high acoustic impedance of the ceramic 92 (˜30 MRayl) limits the amount of sound energy that can be coupled from the rubber. Mechanical coupling can be improved significantly by utilizing a ceramic/epoxy composite to reduce acoustic impedance (˜15 MRayl).

A final example of an intra-oral tissue microphone may incorporate an acoustic vibration sensor based on that described in U.S. Pat. No. 7,433,484. This design incorporates an electret microphone 62 positioned behind an air cavity 66 and diaphragm 60, the diaphragm 60 being in contact with a rubber pad 50 for contact with the tissue (FIG. 3B). The electret microphone is normally intended for external use and incorporates a pressure relief port to the external atmosphere. By hermetically sealing the housing, the sensor may be integrated into the removable dental appliance previously described. The enclosed air 66 in the chamber behind the microphone acts as a stiffness reactance which influences resonance frequency of the device and may counteract the additional mechanical loading due to the added tissue layer.

For buccal side mounting to the upper molars, the intra-oral tissue conduction microphone assembly is contained in a volume of no larger than, e.g., 20 mm (horizontal length)×20 mm (vertical width)×10 mm (profile height), to improve comfort and to maintain concealment during normal activities such as speaking, eating, drinking and smiling. The alternate mounting configuration to the palate requires similar dimensional constraints to minimize the impact on speech and to avoid the gag reflex.

The high capacitance of the PVDF film or electret microphone sensor calls for signal conditioning circuitry positioned as close as possible to the sensor in order to effectively drive further electrical stages. The pre-amplifier may incorporate a high input impedance (e.g., >10 M Ohm) low noise JFET transistor or commercial electret amplifier chip for impedance conversion and signal gain and may be packaged with the sensor in the microphone housing. Band pass filtering may be employed after signal amplification to emphasize the speech frequency range, such as 300 Hz-4000 Hz.

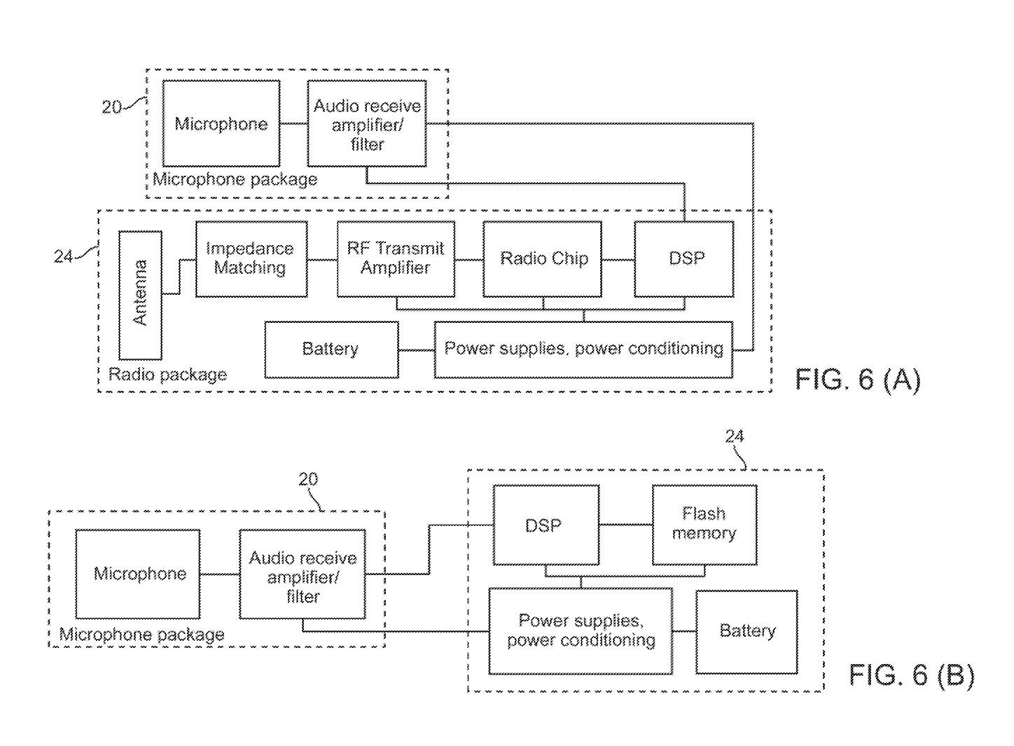

Due to size constraints of the microphone 20 itself, the opposing side 24 of the dental appliance may incorporate additional digital signal processing electronics, transmitter or receiver circuitry (or both), an antenna and battery (e.g. lithium ion), depending on the application (FIG. 6A). In this case, the microphone sensor or pre-amp circuit is hard-wired to battery power and downstream electrical stages by means of a conduit 22 connecting the buccal and lingual sides of the appliance routed behind the rear molars.

The device may be removed from the mouth as necessary depending on intended use or for recharging the enclosed battery. Charging may be accomplished using inductive means (in which an induction coil is required in the dental appliance package) or by direct coupling of exposed electrical contacts.

The removable intra-oral tissue microphone may be used as an integral part of a hearing system, such as a middle-ear or cochlear implant. In this case, the intra-oral microphone would replace the external air-conducted microphone or the subcutaneous implanted microphone. The signals detected by the intra-oral microphone would be processed/filtered, amplified and wirelessly transmitted using e.g. near field magnetic induction (NFMI) or low-power radiofrequency (RF) link to an implanted receiving coil for further signal processing and stimulation of the middle ear or auditory nerve. The intra-oral microphone provides a non-surgical solution for a concealed middle ear or cochlear implant hearing system.

In another use, the intra-oral microphone may be integrated into an intra-oral bone conduction hearing system, where the teeth are caused to vibrate in response to an external signal in which the induced vibrations propagate by bone conduction to the cochlea and the user perceives them as sound. In this system, the tissue microphone and bone transducer may be incorporated into the same dental appliance, whereby the microphone signals are hard-wired to the driving electronics. Alternatively, the microphone is positioned on one side of the mouth and wirelessly transmits the received sound to another appliance positioned on the opposite side of the mouth for driving the teeth. In yet another alternative, the microphone may be positioned on either a lower or upper portion of the mouth and wirelessly transmit received sounds to another appliance positioned on the opposing lower or upper portion of the mouth in a complementary manner. In this manner, the intra-oral tissue microphone constitutes a concealed and removable hearing device.

Further, the intra-oral tissue microphone may be used as part of a communications system, for example, capturing and processing user speech and wirelessly transmitting the signal containing the speech to a phone (e.g., cell phone), radio (e.g., handheld radio), or other communications device capable of receiving and/or transmitting a signal using a standard low power radio communications protocol (e.g. Bluetooth). As described previously, the tissue microphone is insensitive to external air-conducted sounds, so this system would be particularly useful in high noise environments.

Alternatively, the communications system could utilize higher power transmit electronics to increase range to 10-100 m or more, thus enabling the user to wear a fully concealed microphone and communicate with a remotely located receiver. The intra-oral tissue microphone in this case may be used detect user speech, biophysical sounds (e.g. breathing, heartbeat sounds, etc.) or ambient sound.

In a further application, the microphone may be used as part of an intra-oral recording system for monitoring user speech, biophysical sounds or ambient sound. The received signals from the microphone 20 may be stored in a flash memory or other suitable memory storage device housed in the lingual portion 24 of the dental appliance for analysis at a later time (FIG. 6B).

Modification of the above-described assemblies and methods for carrying out the invention, combinations between different variations as practicable, and variations of aspects of the invention that are obvious to those of skill in the art are intended to be within the scope of the claims.

What is claimed is:

1. A removable intra-oral appliance, comprising:
an appliance housing configured for removable attachment to one or more teeth within a mouth of a subject; and,
a microphone supported by the housing whereby the microphone has a contact surface positioned in contact against a mucosal surface within the mouth when the housing is attached to the one or more teeth,
wherein the microphone contact surface has an acoustic impedance which is matched to the mucosal surface.

2. The appliance of claim 1 wherein the appliance housing comprises a structural member extending from the housing and connected to the microphone.

3. The appliance of claim 1 wherein the appliance housing is positioned along a first surface of the one or more teeth and the microphone is positioned along a second opposing surface of the one or more teeth.

4. The appliance of claim 1 wherein the housing further comprises a protrusion opposite to the microphone such that the protrusion is sized to fit in an interstitial space between two adjacent teeth.

5. The appliance of claim 1 wherein the microphone comprises a piezoelectric film supported by a frame secured within the housing, where the piezoelectric film is in vibrational communication with the contact surface.

6. The appliance of claim 5 wherein the piezoelectric film comprises a PVDF film.

7. The appliance of claim 1 wherein the microphone comprises a piezoelectric film secured to the housing and unsupported by a frame, where the piezoelectric film is adhered to and in vibrational contact with the contact surface.

8. The appliance of claim 1 wherein the microphone comprises an electret microphone positioned behind an air cavity and in proximity to a diaphragm in vibrational communication with the contact surface.

9. The appliance of claim 1 wherein the microphone comprises a piezoelectric film supported by a beam which is secured within the housing at a first end of the beam and in vibrational communication with the contact surface at a second end of the beam.

10. The appliance of claim 1 wherein the microphone comprises a first beam having a first frequency resonance and a second beam having a second frequency resonance different from the first frequency resonance, where each of the first and second beams is secured within the housing in proximity to one another such each of the beams is in vibrational communication with the contact surface.

11. The appliance of claim 1 wherein the microphone comprises an internal protrusion in vibrational communication with the contact surface and a piezoelectric film wrapped around the protrusion.

12. The appliance of claim 1 wherein the microphone comprises a piezoelectric ceramic disc in vibrational communication with the contact surface.

13. An intra-oral tissue conduction microphone, comprising:
an enclosure sized for positioning within a mouth of a subject and having a tissue contact portion;
a frame positioned within the enclosure; and,
a piezoelectric film secured to the frame within the enclosure such that actuation by the tissue contact portion applies a force to the piezoelectric film, wherein the enclosure has an impedance which is matched to tissue within the mouth.

14. An intra-oral tissue conduction microphone, comprising:
an enclosure sized for positioning within a mouth of a subject and having a tissue contact portion; and
a piezoelectric film supported within the enclosure such that actuation by the tissue contact portion applies a force to the piezoelectric film, wherein the enclosure has an impedance which is matched to tissue within the mouth.

15. A method of detecting an auditory signal within a mouth of a subject, comprising:
positioning a tissue contact portion of a microphone enclosure against a tissue region within the mouth wherein the tissue contact portion of an enclosure has an acoustic impedance which is matched to the tissue region;
receiving an auditory signal transmitted through the tissue region via the tissue contact portion of the enclosure; and,
actuating a piezoelectric film within the enclosure such that an electric signal representative of the auditory signal is produced.

16. The method of claim 15 wherein positioning a tissue contact portion comprises positioning the tissue contact portion against an inner surface of a cheek of the subject.

17. The method of claim 16 wherein positioning further comprises positioning the microphone enclosure against a surface of a tooth or teeth of the subject such that contact against the inner surface of the cheek is maintained.

18. The method of claim 16 wherein positioning further comprises positioning the microphone enclosure against a gingival surface of the subject such that contact against the inner surface of the cheek is maintained.

19. The method of claim 15 wherein positioning a tissue contact portion comprises positioning the tissue contact portion against a soft palate of the subject.

20. The method of claim 15 wherein positioning a tissue contact portion comprises positioning the tissue contact portion against a gingival surface of the subject.

21. The method of claim 15 wherein receiving an auditory signal comprises imparting a tensile stress within the piezoelectric film such that an electric signal corresponding to the auditory signal is generated.

22. The method of claim 15 wherein actuating a piezoelectric film comprises actuating a PVDF film.

23. The method of claim 15 further comprising transmitting the electric signal representative of the auditory signal to a communications device capable of receiving and/or transmitting a signal.

24. The method of claim 15 further comprising recording the electric signal representative of the auditory signal.

25. The method of claim 15 wherein actuating a piezoelectric film comprises actuating the piezoelectric film secured to a frame within the enclosure.

26. A two-way communication intra-oral appliance, comprising:
an appliance housing configured for removable attachment to one or more teeth within a mouth of a subject;
a microphone supported by the housing whereby the microphone has a contact surface positioned in contact against a mucosal surface within the mouth when the housing is attached to the one or more teeth and wherein the microphone has an acoustic impedance which is matched to the mucosal surface; and,
a transducer in vibrational contact with the mucosal surface where the transducer is configured to detect user-generated sounds through the mucosal surface and the appliance is configured to wirelessly transmit a signal containing the user-generated sounds.

27. The appliance of claim 26 wherein the appliance housing is positioned along a first surface of the one or more teeth and the microphone is positioned along a second opposing surface of the one or more teeth.

28. The appliance of claim 26 wherein the microphone comprises a piezoelectric film supported by a frame secured within the housing, where the piezoelectric film is in vibrational communication with the contact surface.

29. The appliance of claim 26 wherein the piezoelectric film comprises a PVDF film.

30. The appliance of claim 26 wherein the microphone comprises an electret microphone positioned behind an air cavity and in proximity to a diaphragm in vibrational communication with the contact surface.

31. The appliance of claim 26 wherein the appliance is configured to wirelessly transmit the signal to a phone or radio.

32. The appliance of claim 26 wherein the wireless signal is transmitted via a low power radio communications protocol.

33. The appliance of claim 26 wherein the wireless signal is transmitted at a range of 10-100 m.

34. The appliance of claim 26 wherein user generated sounds comprise user-generated speech or biophysical sounds.
